(19) United States
(12) Patent Application Publication
(10) Pub. No.: US 2008/0252614 A1
(43) Pub. Date: Oct. 16, 2008

(54) TOUCH PANEL

(76) Inventors: Naoki Tatehata, Kyoto (JP); Kenichi Matsumoto, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/100,282

(22) Filed: Apr. 9, 2008

(30) Foreign Application Priority Data
Apr. 11, 2007 (JP) 2007-103632

(51) Int. Cl. G06F 3/045

(52) U.S. Cl. 345/174

(57) ABSTRACT

A touch panel has a lower substrate, an upper substrate, and a polarizing plate. The upper substrate is stacked on the upper surface of the lower substrate, and the polarizing plate is stacked on the upper surface of the upper substrate. Lower conductive layers that are insulated from each other and arranged in a first direction are formed on the upper surface of the lower substrate. Upper conductive layers that are insulated from each other and arranged in the second direction perpendicular to the first direction are formed on the upper surface of the upper substrate.

### BACKGROUND OF THE INVENTION

1. Field of the Invention

The present invention relates to a capacitive sensor touch panel that is used mainly for operation of various electronic devices.

2. Background Art

Recently, various electronic devices such as a potable phone and a car navigation system have been enhanced and diversified. Devices that have an optically-transparent capacitive sensor touch panel mounted to the front surface of a display element of liquid crystal or the like have been increased. A user switches various functions of the device, by visually recognizing and selecting a character, mark, or pattern displayed on the display element on the back side through the touch panel, and by touching and operating the touch panel with a finger, a dedicated pen or the like. Therefore, touch panels that are excellent in visibility and easy to operate have been demanded.

Such a conventional touch panel is described with reference to FIGS. 6 and 7. FIG. 6 is a sectional view of the conventional touch panel, and FIG. 7 is an exploded perspective view thereof. For making the structure easy to understand, the sizes of a conductive layer and the other layers are expanded in the drawings. Touch panel 8 has lower substrate 1, upper substrate 4, and sheet 7.

Lower conductive layers 2 are arranged at a predetermined interval from each other on the upper surface of lower substrate 1, and lower electrodes 3 are disposed at the end of each lower conductive layer 2. Upper conductive layers 5 are arranged at a predetermined interval from each other and perpendicularly to lower conductive layers 2 on the upper surface of upper substrate 4, and upper electrodes 6 are formed at the end of each upper conductive layer 5. Optically transparent lower substrate 1 and upper substrate 4 have a film shape. Optically transparent lower conductive layers 2 and upper conductive layers 5 have a band shape and are made of indium tin oxide or the like, respectively.

Optically transparent sheet 7 has a film shape. Upper substrate 4 is stacked on the upper surface of lower substrate 1, sheet 7 is stacked on the upper surface of upper substrate 4, and they are stuck to each other through adhesive layers (not shown) or the like to form touch panel 8.

As shown in FIG. 6, touch panel 8 is mounted on the front surface of liquid crystal display element (LCD) 10 that has polarizing plate 9 on its upper surface, and is mounted in an electronic device. Lower electrodes 3 and upper electrodes 6 are connected to an electronic circuit (not shown) of the device through a connector and a lead wire (not shown).

A user touches and operates the upper surface of sheet 7 with a finger or a dedicated pen in response to the display of LCD 10 in a state where voltage is sequentially applied to lower conductive layers 2 and upper conductive layers 5 through lower electrodes 3 and upper electrodes 6. According to the operation, the capacitance between one of lower conductive layers 2 and one of upper conductive layers 5 in the operated position varies. The electronic circuit detects the operated position based on this variation, and switches various functions of the device.

In other words, the electronic circuit first applies voltage between lower conductive layer 2A and upper conductive layer 5A, and then applies voltage between lower conductive layer 2A and upper conductive layer 5B. Thus, the electronic circuit sequentially applies voltage between lower conductive layer 2A and each upper conductive layer 5. Then, the electronic circuit applies voltage between lower conductive layer 2B and upper conductive layer 5A, and then applies voltage between lower conductive layer 2B and upper conductive layer 5B. Thus, the electronic circuit sequentially applies voltage between lower conductive layer 2B and each upper conductive layer 5. The electronic circuit sequentially switches lower conductive layers 2 and sequentially applies voltage to a plurality of combinations of lower conductive layers 2 and upper conductive layers 5. In this state, for example, when the user touches sheet 7 above the part where lower conductive layer 2B crosses upper conductive layer 5B, the capacitance between lower conductive layer 2B and upper conductive layer 5B varies. The electronic circuit detects the operated position based on this variation, and switches the functions of the device in response to the operated position. Such a touch panel is disclosed in Japanese Translation of PCT Publication No. 2004-535712.

However, touch panel 8 is formed by stacking lower substrate 1 and lower conductive layers 2 on the upper surface of lower substrate 1, upper substrate 4 and upper conductive layers 5, and sheet 7. These components are made of different materials, and have different refractive indices. Therefore, when the touch panel is used in an especially blight environment, for example out of doors or under a fluorescent light, the external light such as the sunlight or lamplight reflects on the boundary surface thereof. As a result, the display of LCD 10 or the like disposed on the back surface of touch panel 8 has poor visibility.

### SUMMARY OF THE INVENTION

The present invention provides an easy-to-operate touch panel where the visibility of the liquid crystal display element or the like disposed on the back surface is high. The touch panel of the present invention has a lower substrate, an upper substrate, and a polarizing plate. The lower substrate has a first surface and a second surface on a back side of the first surface. The upper substrate has a third surface and a fourth surface on a back side of the third surface. The upper substrate is stacked on the lower substrate so that the fourth surface faces the first surface, and the polarizing plate is stacked on the third surface of the upper substrate. Lower conductive layers that are insulated from each other and arranged in a first direction are formed on the first surface of the lower substrate. Upper conductive layers that are insulated from each other and arranged in a second direction perpendicular to the first direction are formed on the third surface of the upper substrate. In this structure, the reflection of the external light can be reduced by half by the polarizing plate. Therefore, using this touch panel, a user can easily see the display of the liquid crystal display element or the like disposed on the back surface, and easily operate this touch panel.

### BRIEF DESCRIPTION OF DRAWINGS

FIG. 1 is a sectional view of a touch panel in accordance with a first exemplary embodiment of the present invention.

FIG. 2 is an exploded perspective view of the touch panel shown in FIG. 1.

FIG. 3A is a partial plan view of a lower substrate of the touch panel shown in FIG. 1.

FIG. 3B is a partial plan view of an upper substrate of the touch panel shown in FIG. 1.

FIG. 3C is a partial plan view of the touch panel shown in FIG. 1.

FIG. 4 is a connection diagram between the touch panel of FIG. 1 and an electronic circuit of a device.

FIG. 5 is a sectional view of a touch panel in accordance with a second exemplary embodiment of the present invention.

FIG. 6 is a sectional view of a conventional touch panel.

FIG. 7 is an exploded perspective view of the touch panel shown in FIG. 6.

### DETAILED DESCRIPTION OF THE INVENTION

### First Exemplary Embodiment

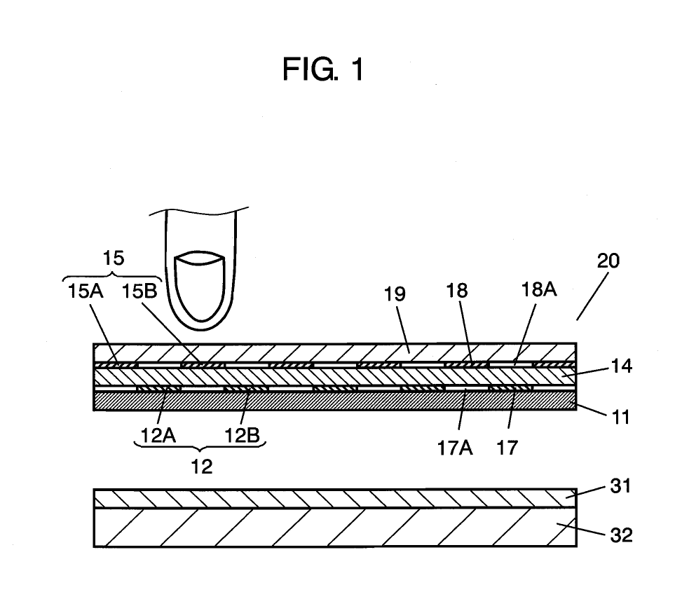

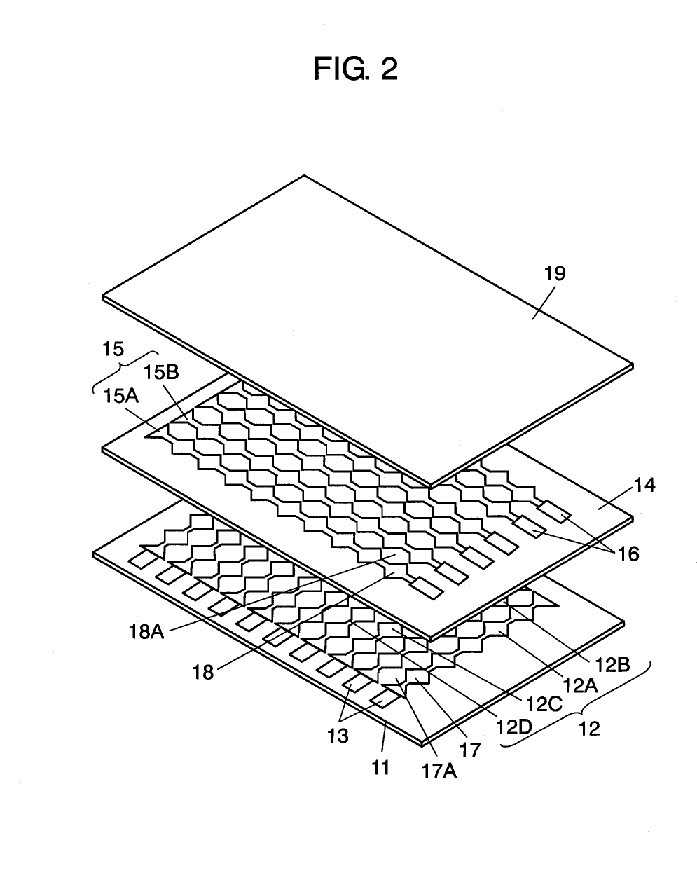

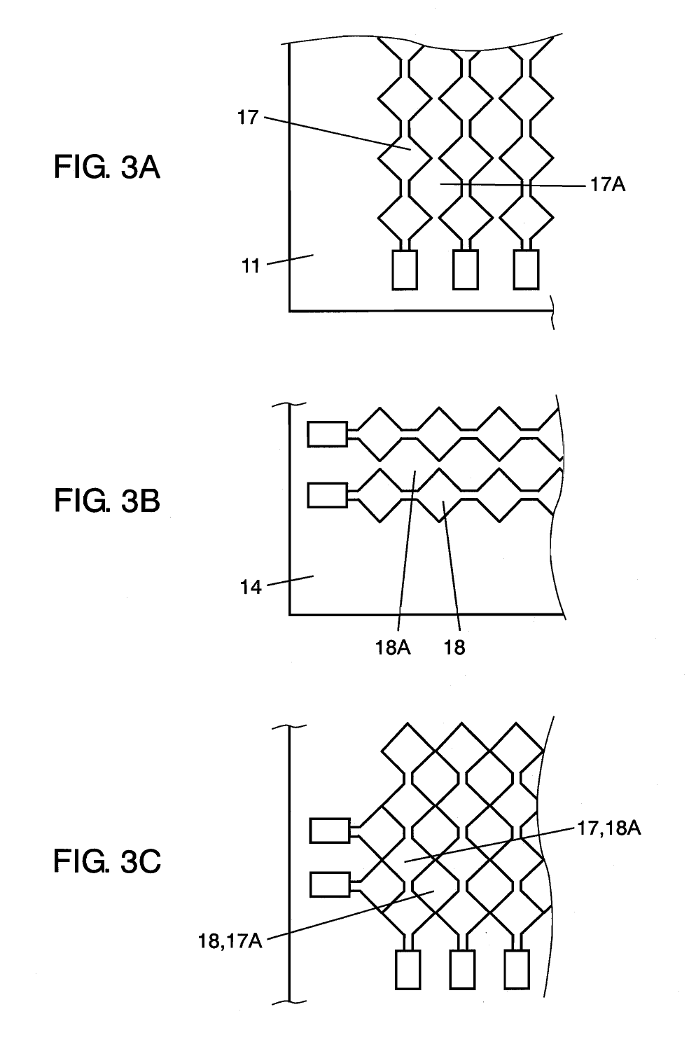

FIG. 1 is a sectional view of a touch panel in accordance with a first exemplary embodiment of the present invention. FIG. 2 is an exploded perspective view of the touch panel. FIG. 3A and FIG. 3B are partial plan views of a lower substrate and an upper substrate of the touch panel shown in FIG. 1, respectively. FIG. 3C is a partial plan view of the touch panel shown in FIG. 1. For making the structure easy to understand, the sizes of a conductive layer and the like are expanded in the drawings. Touch panel 20 has lower substrate 11, upper substrate 14, and polarizing plate 19.

Lower conductive layers 12 are arranged at a predetermined interval therebetween in a first direction on the upper surface (a first surface) of lower substrate 11, and lower electrode 13 is disposed at an end of each lower conductive layer 12. In other words, lower conductive layers 12 are insulated from each other. While, upper conductive layers 15 are arranged at a predetermined interval therebetween in a direction perpendicular to lower conductive layers 12 on the upper surface (a third surface) of upper substrate 14, and upper electrode 16 is disposed at an end of each upper conductive layer 15. In other words, upper conductive layers 15 are arranged in a second direction perpendicular to the first direction and insulated from each other. Upper substrate 14 is stacked on lower substrate 11 so that the lower surface (a fourth surface) of upper substrate 14 faces the upper surface (the first surface) of lower substrate 11.

Optically transparent lower substrate 11 and upper substrate 14 are formed of films of polyethersulfone, polycarbonate, polyethylene terephthalate, or the like. Optically transparent lower conductive layers 12 and upper conductive layers 15 are made of indium tin oxide, tin oxide, or the like. Lower electrodes 13 and upper electrodes 16 are made of silver, carbon, or the like.

Each lower conductive layer 12 is formed by substantially square conductive sections 17 inter-coupled in a band shape, as shown in FIG. 2 and FIG. 3A. Substantially square void sections 17A are formed between lower conductive layers 12. Each upper conductive layer 15 is formed by substantially square conductive sections 18 inter-coupled in a band shape, as shown in FIG. 2 and FIG. 3B. Substantially square void sections 18A are formed between upper conductive layers 15.

Upper substrate 14 is vertically stacked on lower substrate 11 so that void sections 18A overlap on conductive sections 17 and conductive sections 18 overlap on void sections 17A, as shown in FIG. 1 and FIG. 3C. In this positional relation, upper substrate 14 is stuck to lower substrate 11 through an adhesive layer (not shown) of acrylic, rubber, or the like.

Polarizing plate 19 is stacked on and stuck to the upper surface (the third surface) of upper substrate 14. Polarizing plate 19 is formed by stacking flexible retardation layers on upper and lower surfaces of a plate of polyvinyl alcohol or the like. Here, the latter plate is adsorbed with iodine or dye and is stretched and orientated. The retardation layers are formed by stretching films made of cycloolefin-based polymer which is made by polymerizing norbornane or the like. The retardation layers have birefringence, and provide the phase difference of quarter wavelength for transmitted light. Thus, touch panel 20 is formed.

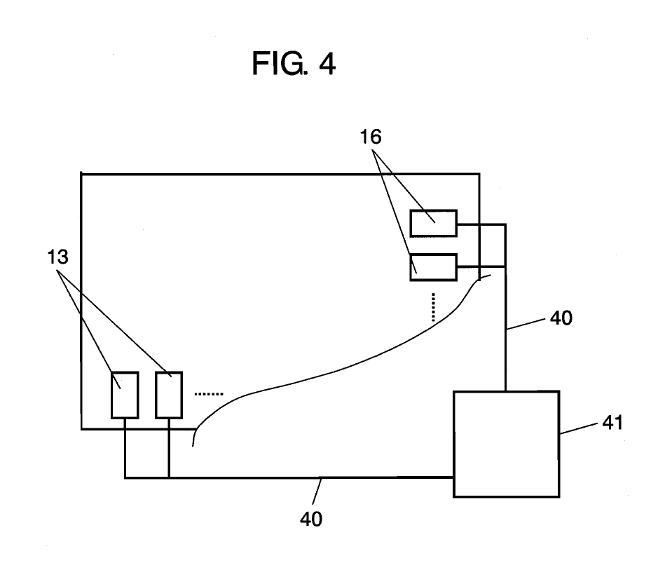

Touch panel 20 is disposed with a gap of 0.2 mm through 0.5 mm on the front surface of liquid crystal display element (LCD) 32 that has polarizing plate 31 on its upper surface, and is mounted to an electronic device. As shown in FIG. 4, lower electrodes 13 and upper electrodes 16 are coupled to electronic circuit 41 of the device through a connector or lead wire 40.

A user touches and operates the upper surface of polarizing plate 19 with a finger or a dedicated pen in response to the display of LCD 32 in the state where voltage is sequentially applied to each lower conductive layer 12 and each upper conductive layer 15 through lower electrodes 13 and upper electrodes 16. The capacitances of lower conductive layer 12 and upper conductive layer 15 in the operated position vary. Electronic circuit 41 detects the operated position based on the variations, and switches various functions of the device.

In other words, when voltage is applied to each lower conductive layer 12 and each upper conductive layer 15 and the user touches polarizing plate 19, the capacitances of upper conductive layer 15B, lower conductive layer 12A, and lower conductive layer 12B vary. Electronic circuit 41 detects the operated position based on these variations, and switches the functions of the device in response to the operated position.

Upper substrate 14 and lower substrate 11 are stuck together in a manner that upper conductive layers 15 are vertically stacked on lower conductive layers 12 so that void sections 18A overlap on conductive sections 17 and conductive sections 18 overlap on void sections 17A. Electronic circuit 41 detects variations in the capacitances of the lower conductive layers 12 and upper conductive layers 15 near the operated position by touch by the finger or the like, not the variation of the capacitance between lower conductive layers 12 and upper conductive layers 15. Therefore, electronic circuit 41 can easily detect the operated position.

In the case that the variation of the capacitance between each of the lower conductive layers and each of the upper conductive layers is detected as in the conventional art, detections are required for each lower conductive layer as many times as the number of combinations between it and all upper conductive layers. While, in the present embodiment, conductive sections 17 and conductive sections 18 are formed vertically and alternately, and the variations of the capacitances of lower conductive layers 12 and upper conductive layers 15 near the operated position are detected. In this case, the number of required detections is simply the sum of the numbers of t lower conductive layers 12 and upper conductive layers 15, so that the operated position can be simply detected.

Alternatively, the operated position can be detected by applying voltage simultaneously to lower conductive layers 12 and upper conductive layers 15. Thus, the detection can be performed in a shorter time. Even if electromagnetic noise or the like from the outside occurs during operation, the detection can be performed under little influence from this.

When touch panel 20 is used in an especially blight environment, for example out of doors or under a fluorescent light, the external light such as the sunlight or lamplight comes from the upside into polarizing plate 19 as an operation surface. When the external light passes through polarizing plate 19, however, the external light becomes linearly polarized light of one of the X direction and the Y direction perpendicular to the X direction, and comes into upper conductive layers 15 and upper substrate 14 that are under polarizing plate 19. For example, when polarizing plate 19 absorbs light wave of the Y direction, the external light becomes linearly polarized light of the X direction.

These components are made of different materials and have different refractive indices of light. The refractive indices of upper substrate 14 and lower substrate 11 are about 1.5, and the refractive indices of upper conductive layer 15 and lower conductive layers 12 are about 1.9. Since the refractive indices are different from each other, the external light is reflected upward from these boundary surfaces, and goes out of the upper surface of polarizing plate 19. However, the reflected light is polarized in the X direction as discussed above, and the intensity of the reflected light is reduced by half.

In other words, polarizing plate 19 is stacked on the upper surface of upper substrate 14, and can reduce the reflection intensity of the external light by half. The user can therefore see LCD 32 on the back surface in a low reflection state, and can operate touch panel 20 easily with high visibility.

Further, when polarizing plate 31 mounted on the upper surface of LCD 32 on the back surface of touch panel 20 absorbs the light wave of the same direction as that of polarizing plate 19, lighting light from LCD 32 is converted into linearly polarized light of the X direction by polarizing plate 31. This linearly polarized light comes out of polarizing plate 19 as it is, so that the user can clearly and visibly recognize the display by LCD 32.

As shown in FIG. 1, it is preferable that touch panel 20 is mounted on the front surface of LCD 32 with a gap of 0.2 mm through 0.5 mm. This arrangement allows prevention of false detection of the operated position of touch panel 20 even if electromagnetic noise or the like occurs from LCD 32.

In the present embodiment, upper substrate 14 is stacked on the upper surface of lower substrate 11. Here, lower substrate 11 has lower conductive layers 12 on its upper surface, and upper substrate 14 has band-like upper conductive layers 15 on its upper surface in the direction perpendicular to lower conductive layers 12. Polarizing plate 19 is further stacked on the upper surface of upper substrate 14. Thanks to this structure, the reflection of the external light such as the sunlight or lamplight can be reduced by half by polarizing plate 19. Therefore, easy-to-operate touch panel 20 where the display of LCD 32 or the like disposed on the back surface is easily seen can be manufactured.

Each lower conductive layer 12 is formed by inter-coupling substantially square conductive sections 17 in a band shape. Each upper conductive layer 15 is formed by inter-coupling a plurality of substantially square conductive sections 18 in a band shape. Upper substrate 14 is vertically stacked on lower substrate 11 so that void sections 18A overlap on conductive sections 17 and conductive sections 18 overlap on void sections 17A. Thanks to this structure, electronic circuit 41 can simply detect the operated position.

### Second Exemplary Embodiment

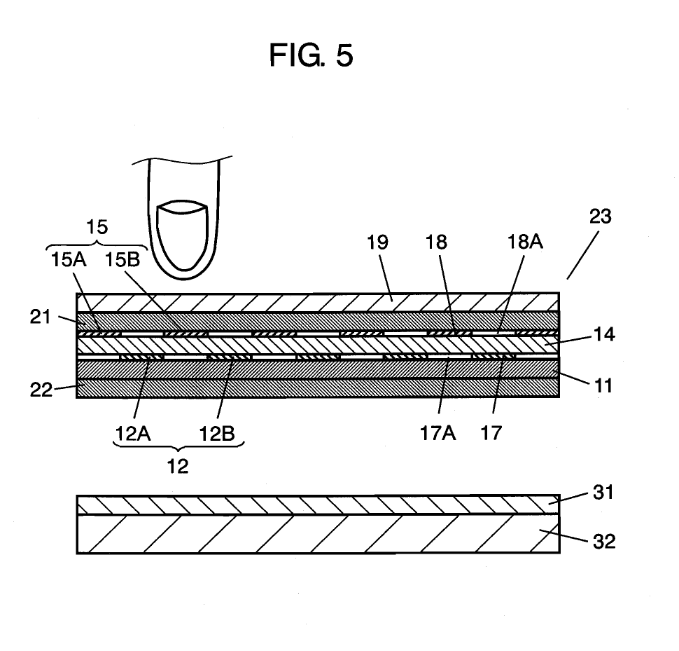

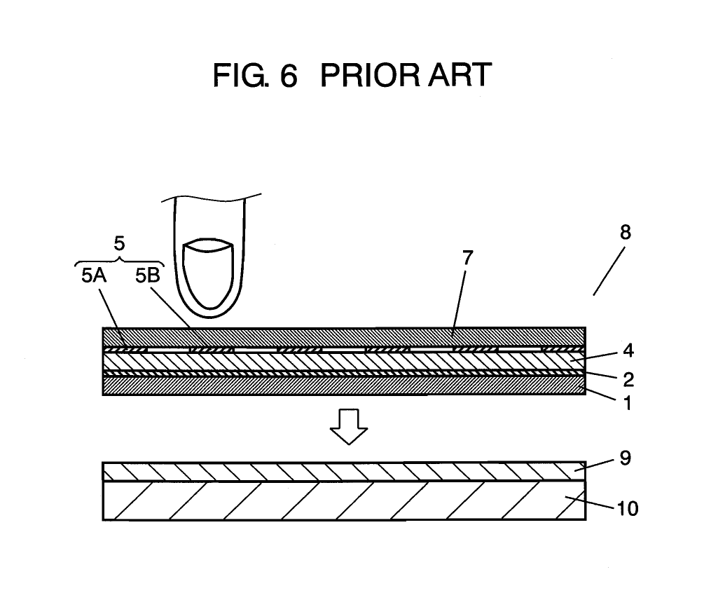

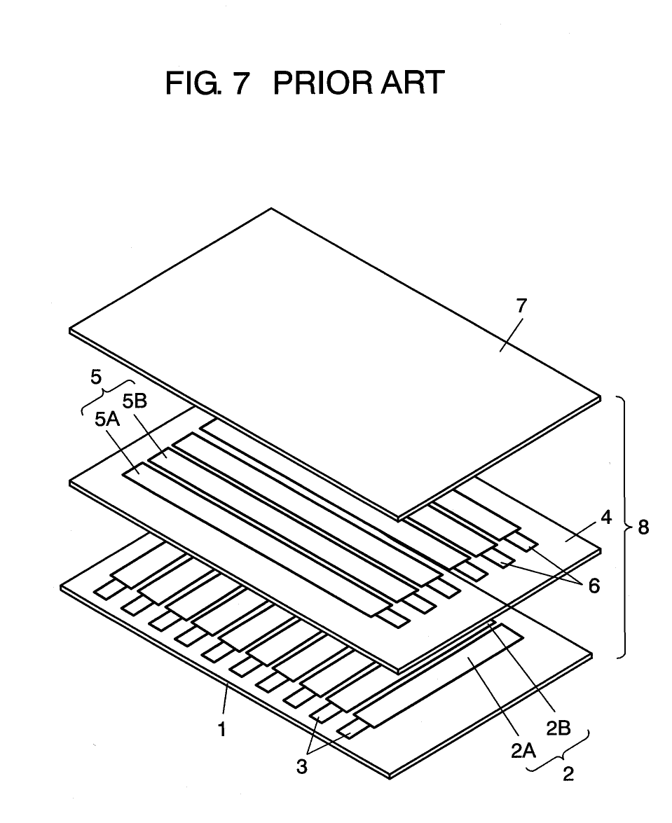

FIG. 5 is a sectional view of a touch panel in accordance with a second exemplary embodiment of the present invention. Touch panel 23 of the present embodiment has upper phase plate 21 and lower phase plate 22 in addition to touch panel 20 of the first exemplary embodiment. Upper phase plate 21 is disposed between upper substrate 14 and polarizing plate 19, and lower phase plate 22 is disposed on the lower surface (a second surface) of lower substrate 11. The present embodiment is the same as the first embodiment except for this structure, so that the descriptions of the same elements are omitted.

Flexible quarter-wavelength upper phase plate 21 and lower phase plate 22 are formed, by stretching films of polycarbonate or cycloolefin-based polymer to provide birefringence for them.

Touch panel 23 is disposed with a gap of 0.2 mm through 0.5 mm on the front surface of LCD 32 that has polarizing plate 31 on its upper surface as shown in FIG. 5, and is mounted to an electronic device.

A user touches and operates the upper surface of polarizing plate 19 with a finger or a dedicated pen in response to the display of LCD 32 in a state where voltage is applied to lower conductive layers 12 and upper conductive layers 15 from electronic circuit 41 shown in FIG. 4. The capacitance in lower conductive layer 12 and the capacitance in upper conductive layer 15 in the operated position vary. Electronic circuit 41 detects the operated position based on the variations, and switches various functions of the device. The detection of the operated position by electronic circuit 41 is the same as that of first embodiment, so that the description is omitted.

When touch panel 23 is used in an especially blight environment, for example out of doors or under a fluorescent light, the external light such as the sunlight or lamplight coming from the upside firstly passes through polarizing plate 19. At this time, the external light becomes linearly polarized light of one of the X direction and the Y direction perpendicular to the X direction, and comes from polarizing plate 19 into upper phase plate 21. For example, when polarizing plate 19 absorbs light wave of the Y direction, the external light becomes linearly polarized light of the X direction and comes from polarizing plate 19 into upper phase difference plate 21. When the linearly polarized light further passes through upper phase plate 21, this linearly polarized light becomes circularly polarized light.

This light downward comes into upper conductive layers 15, upper substrate 14, lower conductive layers 12, and lower substrate 11 that are made of different materials and have different refractive indices of light, and is reflected upward from the boundary surfaces between them. When the reflected light passes through quarter-wavelength upper phase plate 21 again, this reflected light becomes linearly polarized light of the Y direction with a wavelength shifted by half wavelength, and comes into polarizing plate 19. Therefore, the reflected light of the Y direction is blocked by polarizing plate 19.

As described above, the external light having come into touch panel 23 from the upside is reflected from the boundary surface between components of different refractive indices. However, the reflected light is blocked by polarizing plate 19, and hence does not go out of the upper surface of polarizing plate 19 as the operation surface. Therefore, the user can see LCD 32 on the back surface in a no-reflection state, and high visibility can be obtained.

The lighting light from LCD 32 firstly comes into polarizing plate 31. For example, when polarizing plate 31 absorbs the light wave of the X direction and transmits light of the Y direction, the lighting light is converted into linearly polarized light of the Y direction by polarizing plate 31, comes into lower phase plate 22, and then passes through upper phase plate 21. Both lower phase plate 22 and upper phase plate 21 provide a phase difference of quarter wavelength for the transmitted light, so that the transmitted light becomes linearly polarized light of the X direction with a wavelength shifted by half wavelength and comes into polarizing plate 19. Then, the linearly polarized light goes out of the upper surface of polarizing plate 19.

In other words, the lighting light from LCD 32 passes through lower phase plate 22 and upper phase plate 21 to become linearly polarized light of the X direction, and goes out of the upper surface of polarizing plate 19 simply while the wavelength is shifted by half wavelength. Therefore, the user can clearly and visibly recognize the display of LCD 32.

As discussed above, in touch panel 23, polarizing plate 19 is stacked on the upper surface of upper substrate 14, lower phase plate 22 is disposed on the lower surface of lower substrate 11, and upper phase plate 21 is disposed between upper substrate 14 and polarizing plate 19. Thanks to this structure, the external light such as the sunlight or lamplight can be prevented from being reflected, and the visibility of LCD 32 or the like on the back surface is improved. Therefore, the user easily operates touch panel 23.

The structure where lower phase plate 22 is stuck to the lower surface of lower substrate 11 has been described. However, another structure may be employed where lower substrate 11 is not used and lower conductive layers 12 are formed on the upper surface of lower phase plate 22. In this structure, the number of components is reduced, and such a touch panel can be formed inexpensively.

In the first and second embodiments, each lower conductive layer 12 and each upper conductive layer 15 are formed by inter-coupling substantially square conductive sections 17 and 18 in band shapes, respectively. However, the present invention is not limited to this structure. Also when each lower conductive layer 12 and each upper conductive layer 15 are formed in band shapes having substantially the same width, the visibility can be improved.

Thus, the touch panel of the present invention has high visibility and is easily operated, and hence is useful for operation of various electronic devices.

What is claimed is:

1. A touch panel comprising:
a lower substrate having a first surface and a second surface on a back side of the first surface, and having lower conductive layers on the first surface, the lower conductive layers being insulated from each other and arranged in a first direction;
an upper substrate having a third surface and a fourth surface on the back side of the third surface, and having upper conductive layers on the third surface, the upper substrate being stacked on the lower substrate so that the fourth surface faces the first surface, the upper conductive layers being insulated from each other and arranged in a second direction perpendicular to the first direction; and
a polarizing plate stacked on the third surface of the upper substrate.

2. The touch panel according to claim 1, further comprising:
a lower phase plate disposed on the second surface of the lower substrate; and
an upper phase plate disposed between the upper substrate and the polarizing plate.

3. The touch panel according to claim 1, further comprising
an upper phase plate disposed between the upper substrate and the polarizing plate,
wherein the lower substrate is formed of a phase plate.

4. The touch panel according to claim 1, wherein
each of the lower conductive layers is formed by inter-coupling square first conductive sections in the first direction, and first void sections are formed between the lower conductive layers,
each of the upper conductive layers is formed by inter-coupling square second conductive sections in the second direction, and second void sections are formed between the upper conductive layers, and
the upper substrate is stacked on the lower substrate so that the first conductive sections overlap on the second void sections and the second conductive sections overlap on the first void sections.
